(19) United States
(12) Patent Application Publication
(10) Pub. No.: US 2009/0171929 A1
(43) Pub. Date: Jul. 2, 2009

(54) TOWARD OPTIMIZED QUERY SUGGESTON: USER INTERFACES AND ALGORITHMS

(75) Inventors: Feng Jing, Beijing (CN); Shuo Wang, Shanghai (CN); Yang Jiangming, Beijing (CN); Lei Zhang, Beijing (CN)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 11/964,601

(22) Filed: Dec. 26, 2007

(51) Int. Cl. G06F 7/10; G06F 17/30

(52) U.S. Cl. 707/5; 707/E17.017

(57) ABSTRACT

Providing and presenting optimized query suggestions for web searching are described. A method for optimized query suggestion includes utilizing a combination of algorithms to identify query candidates in relationship to the submitted query, calculating a relevance and a frequency for the query candidates in relationship to the submitted query, and generating optimized query suggestions based on a ranked score of the query candidates. The method also includes clustering the optimized query suggestions in a more structured presentation and describing a relationship between the optimized query suggestions and the submitted query in a textual and pictorial description. The method enhances the experience of the user in web searching.

### RELATED APPLICATIONS

The present application is related to commonly assigned co-pending U.S. patent application Ser. No. ______, MS Application No. 308400.01, entitled, “Query-Based Snippet Clustering for Search Result Grouping”, to ______ et al., filed on, ______ 2007; which are incorporated by reference herein for all that it teaches and discloses.

### TECHNICAL FIELD

The subject matter relates generally to web search technology, and more specifically, to improving quality and quantity of web searching by providing and presenting optimized query suggestions.

### BACKGROUND

Web searching provides a great deal of information to individuals who can connect to the Internet with a computing device. A keyword search can instantly return thousands of web pages relevant to the search terms. However, there is room for improvement in how to perform good web searches and in how to best display the results, especially when the results are numerous.

One way to conduct web searching is via query suggestions. Websites and search engines may offer the query suggestions to suggest terms for short, general, and ambiguous queries. However, the current query suggestions have obstacles that spoil both the quality and user experience for web searching.

A problem with web searches is a web search query suggestion may result in a large number of “suggestions”. Therefore, various techniques are needed to display the query suggestions, since the practical display capability of a computer monitor is limited. For example, a display of lengthy query suggestions may not be organized or organized well. Furthermore, the manner of presentations of query suggestions may affect the search tasks, in not being very efficient or useful to the individuals.

Furthermore, a tradeoff may exist between a number of query suggestions and cognitive load. Due to the large number of query suggestions, potentially relevant terms may not be displayed, reducing a chance of addressing the specific information requests of the individuals. In other instances, some search engines may limit a number of suggested query terms to conserve space on the page and to minimize cognitive load. For example, some search engines may offer only one to three suggestion terms on different levels or categories for additional suggestions. Thus, clicking for this additional information may not be worth the effort. Therefore, it is desirable to find ways to suggest relevant query suggestions and how to display the results for the query suggestions for efficient web searching.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In view of the above, this disclosure describes various exemplary methods, computer program products, and user interfaces for presenting and providing query suggestions for web searches. This disclosure describes optimizing query suggestions which may include, but is not limited to, for example, a prioritized presentation and an organized presentation. If an individual submits a query, the related word or phrases that appear frequently during a web search will be suggested for the query suggestions. Thus, the features in this disclosure provide a benefit to individuals by suggesting related words or phrases, which have high-frequent terms and by offering a large scope of query suggestions to choose from for web searching.

In an exemplary implementation, a method for query suggestions utilizes algorithms to identify query candidates in relationship to the submitted query, calculates a relevance and a frequency for the query candidates, and presents the query suggestions based on a ranked score. Furthermore, the method clusters the query suggestions in a more structured presentation and describes a relationship between the query suggestions and the submitted query to enhance the user experience. For example, the algorithms may include, but is not limited to, a query string and frequency algorithm, a query log session algorithm, and a search result content algorithm.

In another exemplary implementation, an user interface for query suggestions includes enabling entry of submitted query and identifying query candidates in relationship to the submitted query, identifying query suggestions based on a ranked score of the query candidates, clustering and presenting the query suggestions, and providing a description of a relationship between the query suggestions and the submitted query.

### BRIEF DESCRIPTION OF THE DRAWINGS

The Detailed Description is set forth with reference to the accompanying figures. The teachings are described with reference to the accompanying figures. In the figures, the left-most digit(s) of a reference number identifies the figure in which the reference number first appears. The use of the same reference numbers in different figures indicates similar or identical items.

FIG. 1 is a block diagram of an exemplary system for improving the quality and user experience of web search results using an optimized query suggestion.

FIG. 2 is an overview flowchart showing an exemplary process for improving the quality and user experience of web search results using the optimized query suggestion.

FIG. 3 is a flowchart showing an exemplary algorithm for the optimized query suggestion of FIG. 2.

FIG. 4 is a schematic diagram showing an exemplary user interface for a prioritized presentation of the optimized query suggestion of FIG. 2.

FIG. 5 is a schematic diagram showing an exemplary user interface for an organized presentation of the optimized query suggestion of FIG. 2.

FIG. 6 is a schematic diagram showing an exemplary user interface with query suggestion terms clustered for the optimized query suggestion of FIG. 2.

FIG. 7 is a schematic diagram showing an exemplary user interface on ambiguous query terms clustered for the optimized query suggestion of FIG. 2.

FIG. 8 is a schematic diagram showing an exemplary user interface for describing a relationship for the optimized query suggestion of FIG. 2.

FIG. 9 is a schematic diagram showing an exemplary mobile search scenario for the optimized query suggestion of FIG. 2.

FIG. 10 is a block diagram showing an exemplary optimized query suggestion system for the optimized query suggestion of FIG. 2.

### DETAILED DESCRIPTION

### Overview

This disclosure is directed to various exemplary methods, user interfaces, and computer program products using a combination of algorithms to present and to provide optimized query suggestions. This disclosure identifies query candidates as query suggestions for the optimized query suggestions. As described herein, a query suggestion may include, but is not limited to, for example, a single keyword or a combination of keywords and any phrases that are popular and related queries and/or functional or semantic similar suggestion cluster terms. The features in this disclosure provide a benefit to users by providing query suggestions that are related or similar words or phrases. In particular, this disclosure helps individuals who are poor in query formulation for web searches and provides a larger scope of query suggestions available for selection by the individuals.

In one aspect, a process utilizes a combination of algorithms to identify query candidates in relationship to submitted query, calculates a relevance and a frequency for the query candidates, presents query suggestions based on a ranked score of the query candidates, clusters the query suggestions in a more structured approach, and describes a relationship between the query suggestions and the submitted query.

In another aspect, the combination of algorithms includes a query string and frequency algorithm, a query log session algorithm, and a search result content algorithm. The combination of these algorithms expands online user search queries by determining if the submitted query, query candidates, and query suggestions are related. The queries are determined to be related if the queries include terms of the submitted query, appear in a substantial number of user query sessions, and have high-frequent terms or phrases of the top search results.

In another aspect, a programming interface enables entry of submitted query and presents query suggestions in relationship to the submitted query using algorithms. The interface also identifies query suggestions based on a ranked score of identified query candidates, clusters and presents the query suggestions in an organized manner, and provides a description of a relationship between the query suggestions and the submitted query to enhance the user experience.

In another aspect, the combination of algorithms in operation with a automatic completion identifies prior submitted queries as query candidates, matches submitted query with prior submitted queries, ranks query candidates by popularity, and offering query suggestion refinements.

The described optimized query suggestion methods improve the searching efficiency and convenience for the user. Furthermore, the described optimized query suggestion methods described expand the results of online search queries and keep the content relevant through use of the algorithms. By way of example and not limitation, the optimized query suggestion methods described herein may be applied to many contexts and environments. By way of example and not limitation, the optimized query suggestion methods may be implemented to support academic and industrial search engines, bidding sites, advertising networks, content websites, content blogs, mobile devices, and the like.

### Illustrative System

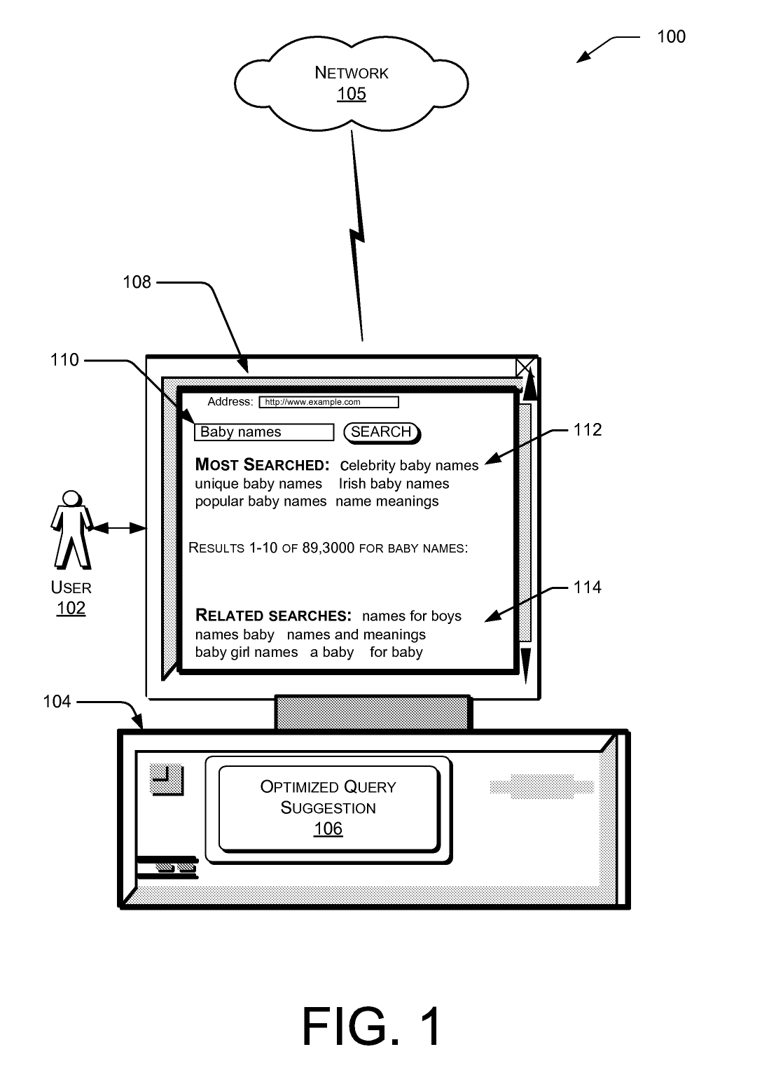

FIG. 1 is an overview block diagram of an exemplary system 100 for improving the quality and user experience of web search results using an optimized query suggestion. A user 102 shown with a computing device 104 enables the user 102 to enter a keyword and initiates a web search on the internet 105. The terms query, keyword, and target may be used interchangeably to describe the word the user submits for a web search. Computing devices 104 that are suitable for use with the system 100, include, but are not limited to, a personal computer, a laptop computer, a desktop computer, a workstation computer, a personal digital assistance, a cellular phone, and the like.

The system 100 may provide an optimized query suggestion application program 106 as, for example, but not limited to, a tool, a method, a solver, software, an application program, a service, technology resources which include access to the internet, and the like. Here, the optimized query suggestion application program 106 is illustrated as an exemplary application program, referred to as optimized query suggestion application program 106. This optimized query suggestion application program 106 provides query suggestions that are related words or phrases in response to a user-entered search keyword or phrase. Here, the optimized query suggestion application program 106 includes algorithms for suggesting and expanding online user search keywords while keeping the query suggestions relevant and related.

A display monitor 108 illustrates an implementation of an exemplary optimized query suggestion application program 106. In this exemplary optimized query suggestion application program 106, query suggestions are considered related if the query suggestions include terms of the submitted query, appear in a substantial number of user query sessions, and have high-frequent terms or phrases of the top search results. These related query suggestions may be grouped together. Next, the query suggestions are grouped as similar types, if the query suggestions have a relevance and a frequency score that are similar and in a top rank.

The exemplary optimized query suggestion application program 106 shows user-submitted query, “baby names” at 110. In an exemplary implementation, the optimized query suggestion application program 106 presents the query suggestions in a prioritized presentation.

Shown at 112 is “Most Searched”, which illustrates these query suggestions are the ones that are most searched by individuals. For example, if the user 102 types in the words “baby names” 110 as the user submitted query, then the most searched phrases are suggested by the optimized query suggestion program 106. Shown in “Most Searched” 112, query suggestions may be broken down which includes “celebrity baby names, unique baby names, . . . ”, phrases based on popular queries.

Shown at 114 is categorizing the query suggestions into “Related Searches” based on popular queries. For example, if the user 102 types in the words “baby names” 110 as the user submitted query, then a variety of related phrases, which are popular are suggested by the optimized query suggestion program 106. Thus, the optimized query suggestion application program 106 provides query suggestions that are relevant for the user submitted query.

### Illustrative Process

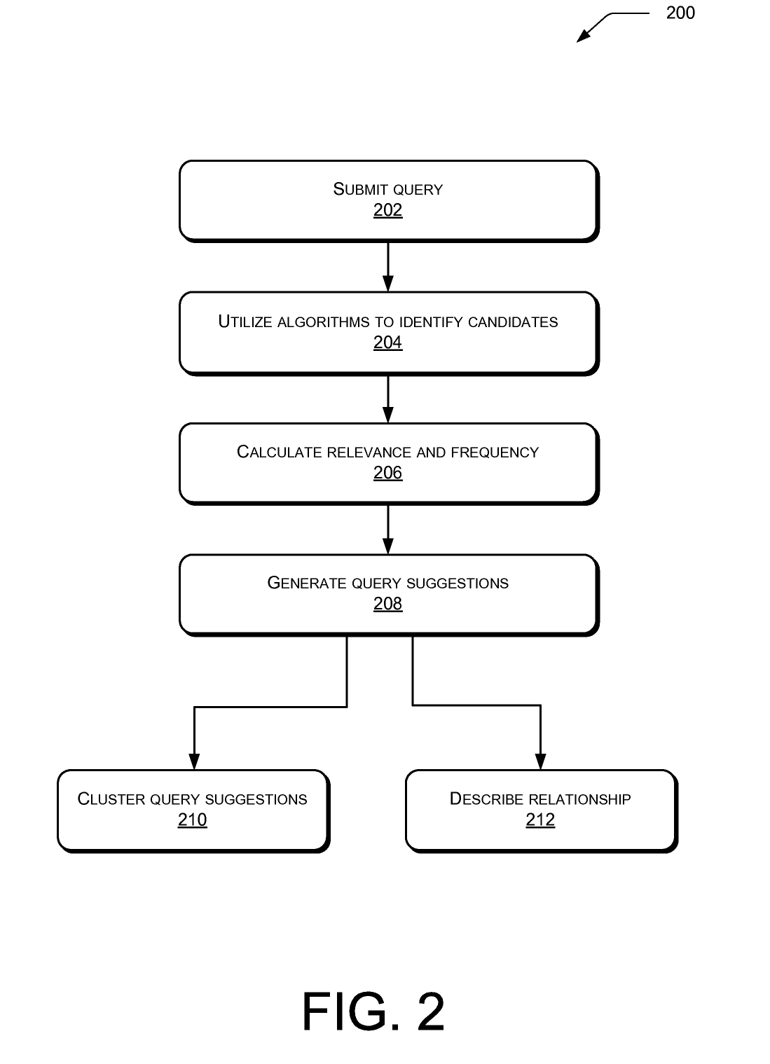

Illustrated in FIG. 2 is an overview exemplary flowchart of a process 200 for implementing the optimized query suggestion to provide a benefit to users 102 by suggesting queries, which are related to the user submitted query. For ease of understanding, the method 200 is delineated as separate steps represented as independent blocks in FIG. 2. However, these separately delineated steps should not be construed as necessarily order dependent in their performance. The order in which the process is described is not intended to be construed as a limitation, and any number of the described process blocks maybe be combined in any order to implement the method, or an alternate method. Moreover, it is also possible that one or more of the provided steps will be omitted.

The flowchart for the process 200 provides an example of the optimized query suggestion application program 106. Shown at block 202, the user 102 submits a query for web searching. As mentioned, optimized query suggestion application program 106 helps users 102 who are poor in query formulation and provides a larger scope for the user 102 to select from a long list of query suggestions.

Shown at block 204, the process 200 utilizes a combination of algorithms to identify query candidates for the user submitted query. The process 200 may include but is not limited to, a combination of algorithms that are integrated to work cooperatively. In one implementation, the process 200 utilizes a query string and frequency algorithm, a query log session algorithm, and a search result content algorithm.

These multiple algorithms identify related query candidates by determining if the query candidates are related. In the first algorithm, the query string and frequency (QSF) algorithm determines the query candidates are related to the submitted query if there are terms of the submitted query. For example, name entities, location entities, and the like may be included into query candidates to improve performance. The basic assumption of QSF-based algorithm is that query candidates are related to the user submitted query if they contain all terms of it. For the related queries, the more frequent means more relevant.

In the second algorithm, the query log session (QLS) algorithm determines the query candidates are related if the query candidates appear in a substantial number of user query sessions, where the queries may be consecutive. Again, name entities, location entities, and the like may be included into query candidates to improve performance. The query log session algorithm identifies related key phrases and uses a key phrase extraction algorithm to find related key phrases from top search results of the given query. Key phrases extracted from both resources are further combined to form a unified phrase-level representation of the query. Thus, query candidates are ones that are most similar (i.e., relevance) queries and the most frequent queries in a database. Basically, a query log records and reflects the search intentions of the user 102. Thus, log-based algorithms tend to be more effective for popular queries with sufficient data in the database. QLS-based algorithms leverage the knowledge of query re-formulations from numerous searchers. Therefore, relevant query suggestions, which do not contain the original query strings, will be suggested.

In the third algorithm, a search result content (SRC) algorithm determines query candidates are related if the query candidates have high-frequent terms or phrases of the top search results. Again, name entities, location entities, and the like may be included into query candidates to improve performance. The related key terms or phrases may be extracted using the search result clustering algorithms. For example, “tiger tank” and “animal” may be extracted for query “tiger”. Search result represents an understanding of the submitted query from the perspective of a search engine. Search results-based algorithms may be used for unpopular queries with insufficient data in the database. The SRC-based algorithms are independent of query logs and are helpful for queries that are unpopular.

At block 206, the optimized query suggestion process 200 calculates a relevance and a frequency for the query candidates. When a user 102 submits a query, the process 200 determines its representation by both search result context and query session context. The process 200 calculates the similarity with all existing query candidates, ranks them by score function and suggests the relevant top queries. The process 200 may handle both popular queries and non-popular queries. As each query term is expressed as a ranked key phrases list, the similarity between each pair queries is calculated, as shown below:

$$\begin{matrix}R ( {q}_{1} , {q}_{2} ) = α \cdot \sum {R}^{′} ( {P}_{i} \vert {q}_{1} ) {R}^{′} ( {P}_{i} \vert {q}_{2} ) + \\ β \cdot \sum {R}^{″} ( {P}_{j} \vert {q}_{1} ) {R}^{″} ( {P}_{j} \vert {q}_{2} ) .\end{matrix}$$

To help explain the equation above, q is a query, where q may be expressed with a ranked list as shown below:

q={R′(pᵢ|q)}.

As part of the process, the query by search result context includes finding the ranked phrase list pᵢ, and R is the function that calculates probability that pᵢ is relevant to q.

Thus, these functions are shown in the equation below:

$${R}^{′} ( p \vert q ) = \frac{f ( p )}{F ( p )} .$$

Where F(p) represents the frequency of p if p is a query, otherwise, a constant 1 is used instead of F(p).

Based on the query representation and similarity function, the relevance score of a query q′ for the user submitted query q is:

Score(q′|q)=δ·R(q′, q)+ψ19 Log F(q′).

The left part of the score function represents the similarity between query q′ and q, and the right part represents the importance of query q′. Similar to the search engine, both dynamic rank and static rank are considered and linearly combined as in a Webpage search.

Block 208 generates query suggestions based on the ranked score of the query candidates. Next, the process 200 clusters the query suggestions for a more structured presentation to improve the user experience in terms of reducing processing time.

Based on the unified query optimized query suggestion application 106, this process 200 offers two additional features to enhance the user experience. At block 210, one feature is clustering the suggested query terms at for a more structured, organized approach. Different manner of presentations of query suggestions affect the search tasks, and a more structured organization improves the efficiency of query suggestions. Typically, the existing query suggestion services may not support organization of query terms because query terms are too short and there is not enough information from the short terms. Depending only on these short terms makes it very difficult to define the relevance function. The clustering 210 may be conducted on the query suggestion terms to remedy randomness and chaos.

Block 210 further identifies getting a well defined relevance function between the two query suggestions. Thus it is very easy to re-organize the query suggestion list with some traditional clustering method, e.g. Average-Link Clustering method. Suppose there are two suggestion sets A and B, the distance between the two sets may be described as follows:

Dis(A, B)=Max{R(q₁, q₂): q₁ ε A, q₂ ε B}.

Alternatively, the clustering 210 may be performed on ambiguous queries as the quested terms of different concepts may be mixed up and create unexpected confusion.

Block 212 shows the second feature in presenting the query suggestions. This feature describes a relationship of the query suggested terms to the user submitted query. Block 212 describes how this feature enhances a comprehension of query suggestions that are non-expansion terms.

Furthermore, describing the relation between the suggested query and the user submitted query, also known as target query may help users 102 to further formulate their queries. When submitting two query terms together to a search engine that is based on a proximity strategy for queries in the search engine, the results will include both of the two query terms with higher priority than other results, such as “snippet results”. In other words, the relationship between the suggested query and user submitted query enables leveraging snippet content. The snippet content occurs when submitting two query terms together to a search engine, receiving search results, and picking the best snippet content from these search results. Thus, the process 200 may determine the relationship information 212 from these results. This process 200 may convert a relationship extracting problem to a results ranking problem.

The process 200 may also represent this joint query (joint two queries with a blank) with a ranked phrases list shown in the equation below:

jq={R′(pᵢ|jq)}.

Also, the relevance for each snippet may be expressed as follows:

SRᵢ=Σ R′(Pⱼ|jq), for each pⱼ appear in i^{th} snippert.

Where R′ function denotes the importance of phrase p to the joint query, SR function will rank the snippet, which contains more important contents with the higher score. Thus, the process 200 chooses a top relationship to show to the user 102.

Similar to the textual relationship snippet, the process 200 submits the joint query to an image search engine and retrieves a first picture for the description. Textual and pictorial description of the relationship between the user submitted query and the optimized query suggestion are provided to help users 102 understand the suggestions.

### Exemplary Search-Based Query Suggestion

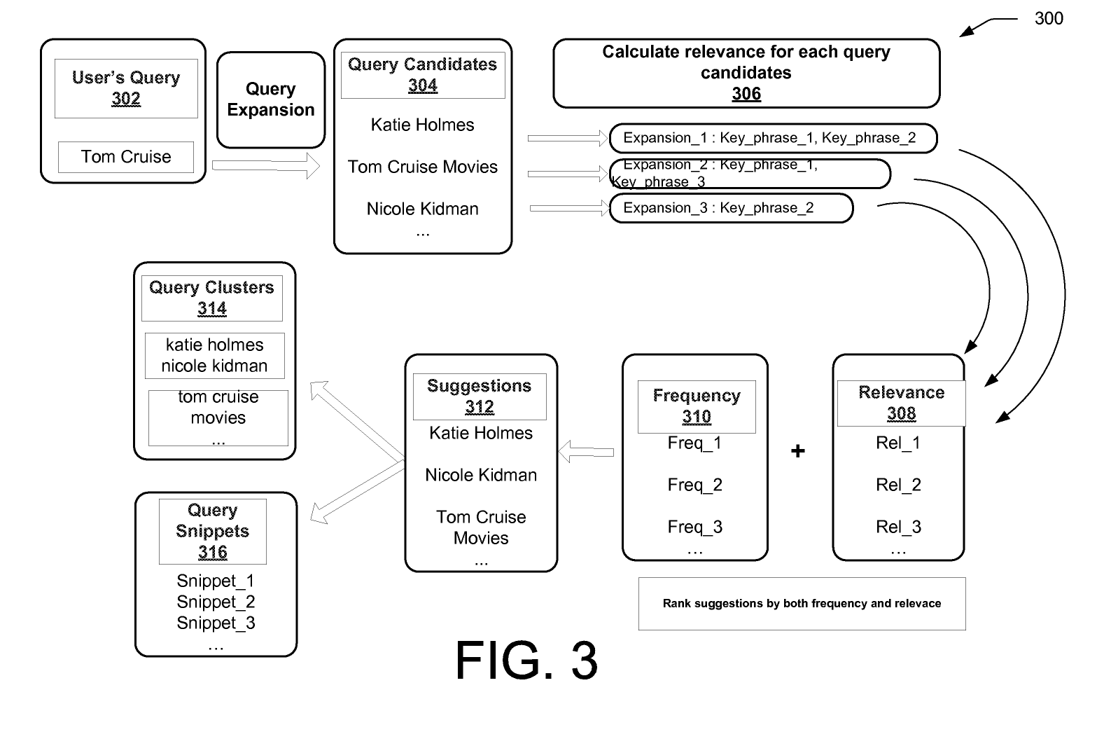

FIG. 3 is a flowchart that illustrates an exemplary flow process for implementing a search-based query suggestion process 300 for the optimized query suggestion. Shown at block 302, the process 300 receives user's query, such as Tom Cruise.

One way to expand the query is to use the Term Frequency and Inverse Document Frequency (TF-IDF) representations of top search results to represent the queries, thus converting the semantic representation problem into a supervised ranking problem. TF measures the frequency of a term in a document. The higher the term frequency is, the more important the term is for the document. Document frequency measures the frequency that a term appears in a document. The higher the document frequency is, the more common the term is and the less important the term is. Inverse document frequency is to inverse the definition so that it can be multiplied with TF. Thus, this weight is a statistical measure to evaluate how important a word is to a document in a collection or a corpus.

Given a query q, q may be expressed with a ranked list as shown below:

q={R′(pᵢ|q)

The query by search result context includes finding the ranked phrase list pᵢ, and R is the function that calculates probability that pᵢ is relevant to q. The algorithm to find this ranked list may be split into these steps: retrieve salient words, combine key phrases, and calculate the relevance and rank key phrases.

Block 304 illustrates identifying query candidates 304, which are related words and phrases to the user submitted query if there are high-frequent terms or phrases of the top search results. Search result represents an understanding of the query from the perspective of a search engine. Here, the block 304 illustrates query candidates which include but is not limited to, Katie Holmes, Tom Cruise Movies, and Nicole Kidman. The process 300 may receive a WebPages search result returned by a certain Web search engine. Since most search engines are well designed to facilitate relevance judgment of the user 102 only by the title and snippet, the process 300 assumes the contents are informative sufficient to retrieve the feature representation.

Block 306 illustrates calculating a relevance for each query candidates. The related key words may be effectively extracted by counting occurrences with the given query in titles and snippets. In the following equation,

$$f ( w ) = \frac{\vert D ( w ) \vert}{\vert D \vert} .$$

Where f(w) is a normalized frequency of w, since different queries may have different number of results and some non-popular queries may have only few results. The equitation shows the current word as w, the set of whole documents D, and the set of documents that contains w as D(w).

In most cases, phrase-level representation is more reasonable than word-level representation. For example, for the user submitted query “tiger”, the key phrases are tiger woods, white tiger and etc. Using the word-level features, queries with results containing woods, white will be considered relevant.

Furthermore, phrase-level representation is especially effective for the names of people. There may be several highly related key phrases for these queries, which are also the names of people. Considering many names of people have the same surname, using the words as features, some queries with the results will contain the same surname but different first names will be ranked high. Thus, the key phrase may be constructed by combining the interrelated words.

Block 308 illustrates calculating the relevance of two words a and b. The process 300 constructs the key phrase by combining the interrelated words.

$$r ( ab ) = \frac{\vert D ( ab ) \vert}{Max \{ \vert D ( a ) \vert , \vert D ( b ) \vert \}} .$$

Words a and b will be combined into a phrase only when r(ab) is greater than a threshold (for example, a constant 0.5).

Block 310 illustrates determining a frequency for the query candidates in relationship to the submitted query. The normalized frequency for a phrase is similar to a word as shown in the equation below:

$$f ( p ) = \frac{\vert D ( p ) \vert}{\vert D \vert} .$$

This process 300 is iterated by treating the new generated phrase as a word until no new phrase is generated. Similar to the TF-IDF weighting, this process 300 uses phrase frequency multiplied by inverted query frequency to weight the phrases. The inverted query frequency is used to deemphasize those general phrases that related to almost all queries, e.g. “contact us”, since it appears in a lot of WebPages.

Shown in the equation:

$${R}^{′} ( p \vert q ) = \frac{f ( p )}{F ( p )}$$

Where F(p) represents the frequency of p if p is a query, otherwise, a constant 1 is used instead of F(p).

The process 300 operates in conjunction with a query session (not shown in 300). The queries that occur with the user submitted query 302 occurs in a certain number of query sessions may be used as key phrases. Queries are related if they appear in a substantial number of user query sessions (consecutive queries). Query session-based algorithms leverage the knowledge of query usage history from numerous users. Therefore, useful queries, which do not contain the original query strings, will be suggested. For example, “Nicole Kidman” is suggested for “Tom Cruise”.

Representing query by query session context is similar to the search result context, and its relevance function may be expressed in the following equation.

$${R}^{″} ( p \vert q ) = \frac{S ( p , q )}{S ( p )} .$$

Where S(p,q) represents the number of sessions containing both p and q, S(p) is the number of sessions containing p. Since each query term may be expressed as a ranked key phrases list, the process 300 calculates similarity between each pair queries.

Based on optimized query suggestion application program 106, the process 300 has the two additional features as mentioned in FIG. 2. The first feature is clustering the suggested query terms, shown as query clusters block 314.

Block 316 describes the relation between the suggested query and the target query, which may help users to further formulate their queries.

### Exemplary User Interfaces

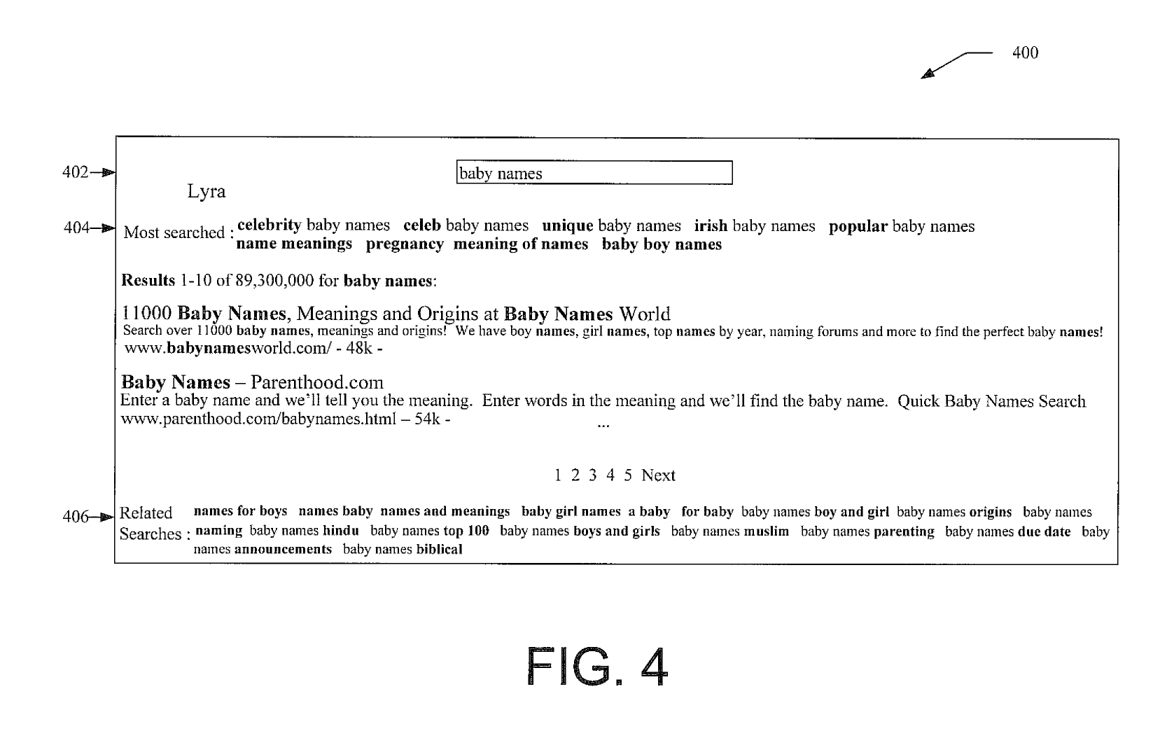

FIGS. 4-9 illustrate schematic diagrams of exemplary user interfaces usable with the optimized query suggestion application program 106 of FIG. 2. FIG. 4 is a schematic diagram showing an exemplary user interface for a prioritized presentation of the optimized query suggestion of FIG. 2. The exemplary prioritized user interface 400 is based on users sharing a large portion of search needs. Thus, popular queries and related query suggestions cover a significant part of the web searches.

Block 402 allows the user to submit query, such as “baby names”. In this implementation, the prioritized user interface presentation 400 illustrates categorizing the query suggestions into two areas based on popularity.

Block 404 illustrates “Most Searched” shown at the top. The relatively small numbers of queries (no more than 100 characters per line), labeled as “Most Searched” 404 at the top of the search results, satisfy most of the search needs without significant increase in browsing and cognitive load.

Block 406 shows “Related Searches” shown at the bottom. The suggestions in the “Related Searches” 406 at the bottom, serve as complementary queries to ensure the coverage and relevance of query suggestions. Thus, the optimized query suggestion application program 106 provides query suggestions that are relevant for the submitted query.

### Organized Presentation

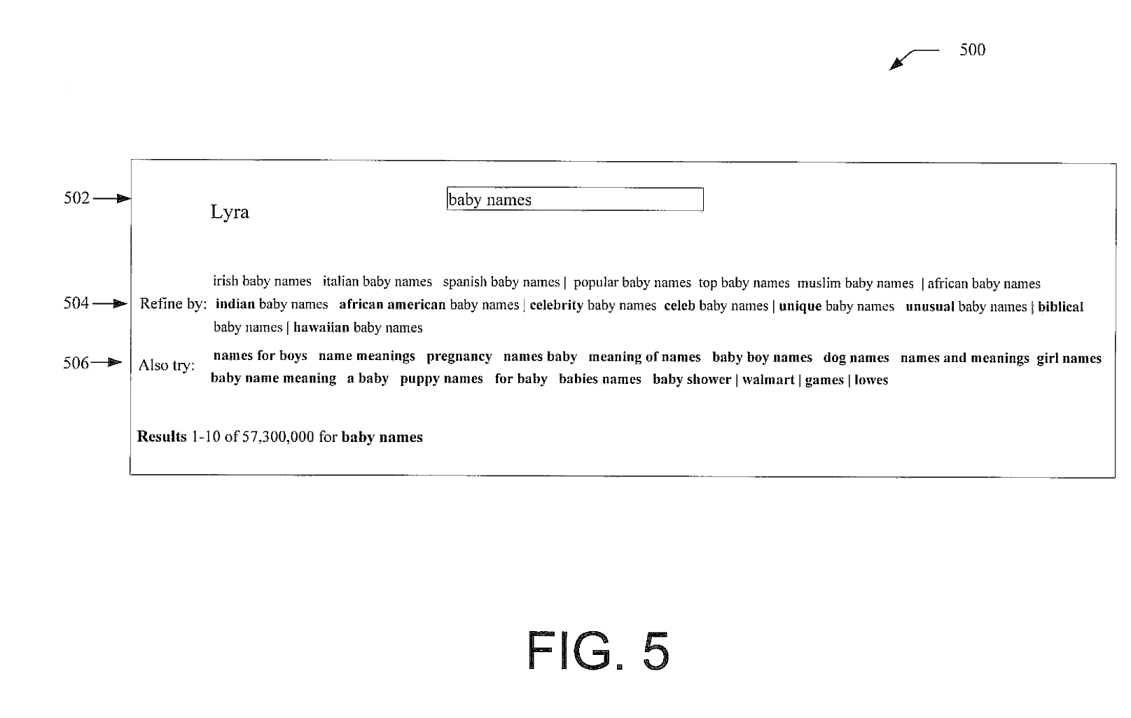

FIG. 5 is a schematic diagram showing an exemplary user interface for an organized presentation 500 of the optimized query suggestion of FIG. 2. This user interface for organized presentation 500 is based according to the cognitive processing theories. The theories are that a semantically or a functionally similar suggestion cluster does not exert a more significant load than a single query.

Block 502 illustrates the user submitted query “baby names”. The process shows how two measures are applied to display the query suggestions in a more organized manner or in cognitive chunks.

Block 504 illustrates how query suggestions are classified by function of “refine” or “expand” the search result respectively into “Refine by”. “Refine by” 504 includes queries formed by the original query and a modifier and possible refinements.

Block 506 illustrates how the query suggestions are classified by “Also try”. The “Also try” 506 includes related queries, containing no or only part of the original query, such as “names for boys”. As shown, the queries are organized in clusters by semantic similarity with the symbol of “|” to separate the two neighboring clusters.

### Clustering for Query Suggestions

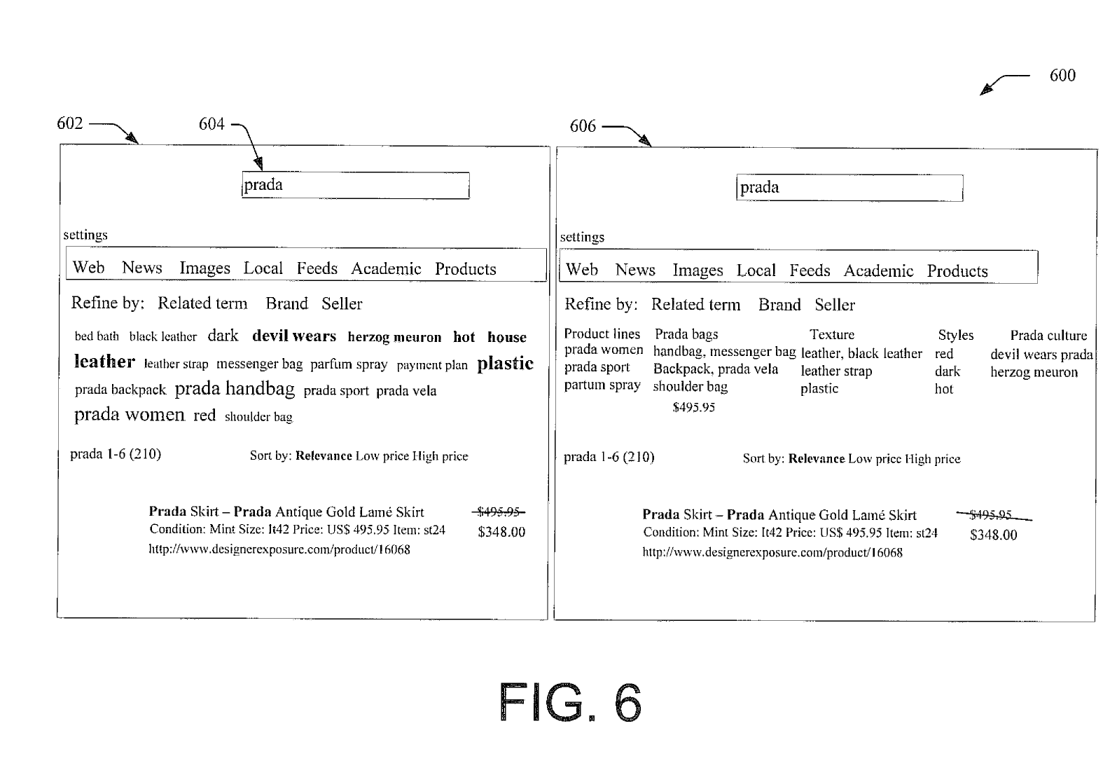

FIG. 6 is a schematic diagram showing an exemplary user interface with query suggestion terms clustered in a more structured presentation 600 of the optimized query suggestion. This clustering presentation helps to enhance an user experience and to improve efficiency for web searching.

Block 602 on the right side, illustrates the query suggestions that are presented with no particular order or pattern. Block 604 illustrates the user submitted entry, “prada”.

Block 606 illustrates a more structured presentation, which may improve the user experience in term of reducing processing time. Block 606 occurs with clustering of the query suggestion terms, which helps remedy randomness and chaos when presented with the query suggestions to users.

For example, the query suggestions shown in 602 may be categorized as the following list and presented as 606. Block 606 illustrates categories of:

[Product lines] prada women, prada sport, partum spray

[Prada Bags] handbag, backpack, shoulder bag, messenger bag, prada vela

[Texture] leather, leather strap, plastic, black leather

[Styles] dark, red, hot

[Prada Culture] devil wears prada, herzog meuron.

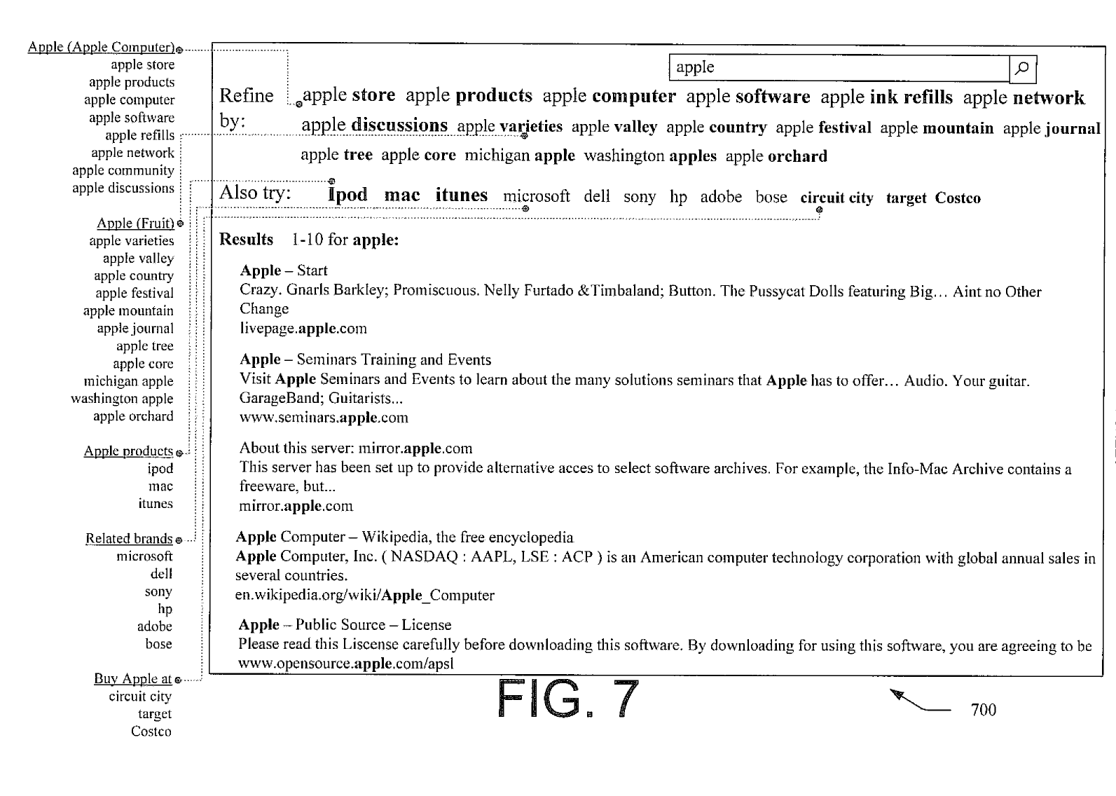

FIG. 7 is a schematic diagram showing an exemplary user interface on ambiguous query terms clustered in a more structured presentation 700 of the optimized query suggestion. Without any type of clustering, the quested terms of the different concepts may be mixed up and cause unexpected confusion. Thus, this presentation provides a benefit to the user.

Relationship between Query Suggestions and Submitted Query

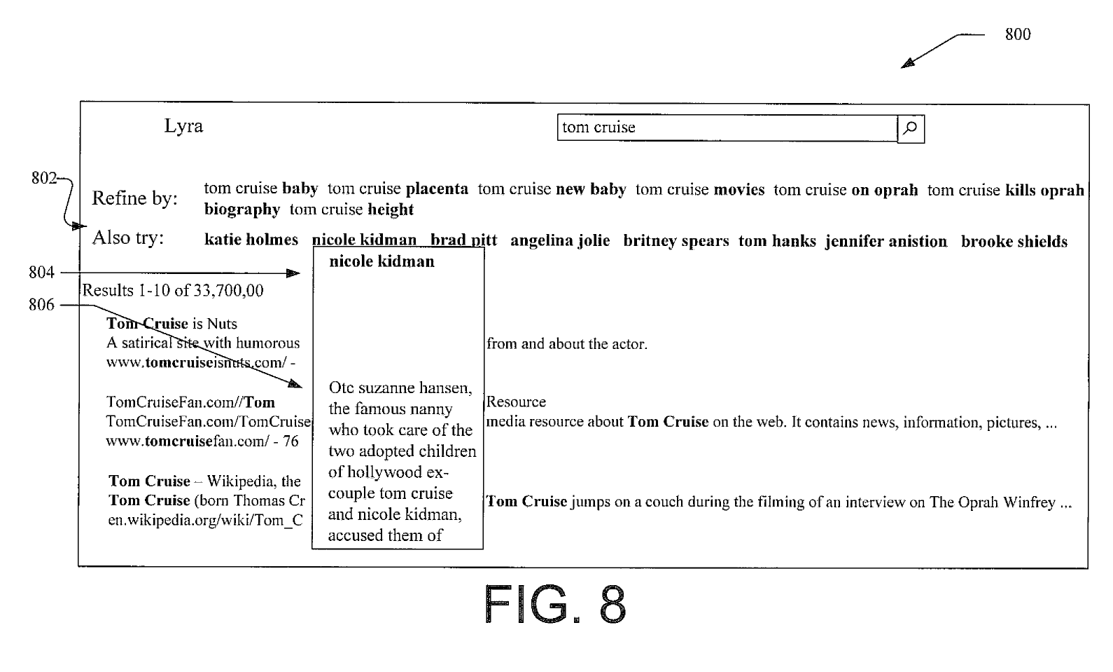

FIG. 8 is a schematic diagram showing an exemplary user interface for describing a relationship between the query suggestions and the submitted query 800 of the optimized query suggestion. This user interface 800 describes a feature to enhance the comprehension of “also try” 802 query suggestions (non-expansion terms). The “also try” queries (non-expansion terms) expand the scope of the user's query at the cost of introducing unknown relationship among the user's original query and the “also try” terms.

For example, “Nicole Kidman” is suggested for the query “Tom Cruise”, but users may not know the relationship between “Tom Cruise” and “Nicole Kidman”, thus be confused with this suggestion term. Describing the relation between the suggested query and the target query may help users to further formulate their queries. By default, the rich snippet for the non-expansion terms is invisible. Hovering on the terms for a given time will trigger the rich snippet of that specific term. Clicking on the image or the text link on the snippet will lead the user to the search results of the suggestion or a more detailed page about the relationship of the suggestion and the original query. The snippet will disappear if the mouse cursor falls off the suggested terms.

Shown at 802 is the title: the “also try” term; at 804 is a thumbnail of the term; and at 806 is a textural description which both contains the original query word(s) and the “also try” term(s). The thumbnail image is retrieved by an image search engine with both the original query and the suggestion as the query.

### Mobile Search Scenario

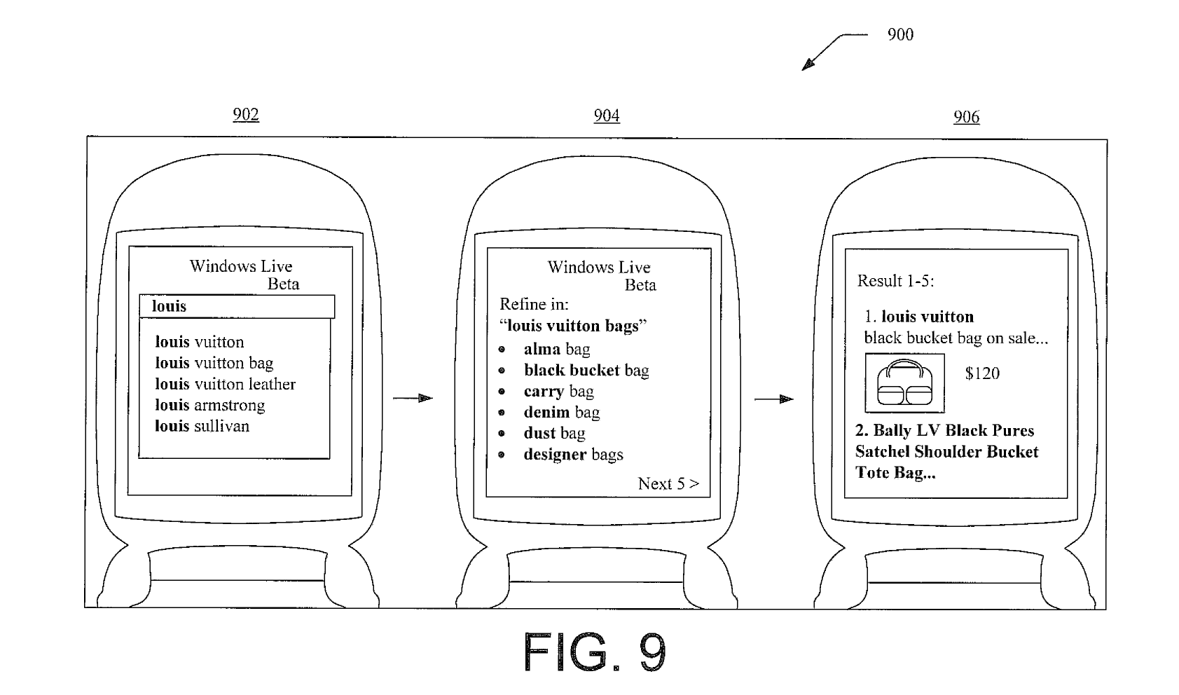

FIG. 9 is a schematic diagram showing an exemplary mobile search scenario 900 using the optimized query suggestion. The mobile search scenario 900 uses the combination of algorithms in operation with a automatic completion which identifies prior submitted queries as query candidates, matches submitted query with prior submitted queries, ranks query candidates by popularity, and offers query suggestion refinements. Automatic Completion and Query Suggestion may significantly save the key presses in a cell phone, thus improving the efficiency and providing a benefit to users with more query options.

When the user wants to find information of Louis Vuitton bags, the process are: As the entry extends, the completion candidates also appears. In this case, the user input a query start by entering the words “louis” as shown in 902. The auto completion feature will then suggest the completed query candidates, shown in 904. The source of the auto-completion query candidates is the prior submitted query to the service. The process matches the user input query string with the prior submitted query to form the list. The ranking of the queries may be determined by popularity. Query substitutions may also be considered as auto-completion candidates. After selecting “louis vuitton bags”, the query suggestions allow the user to choose from the refinements shown in 906.

### Exemplary Optimized Query Suggestion System

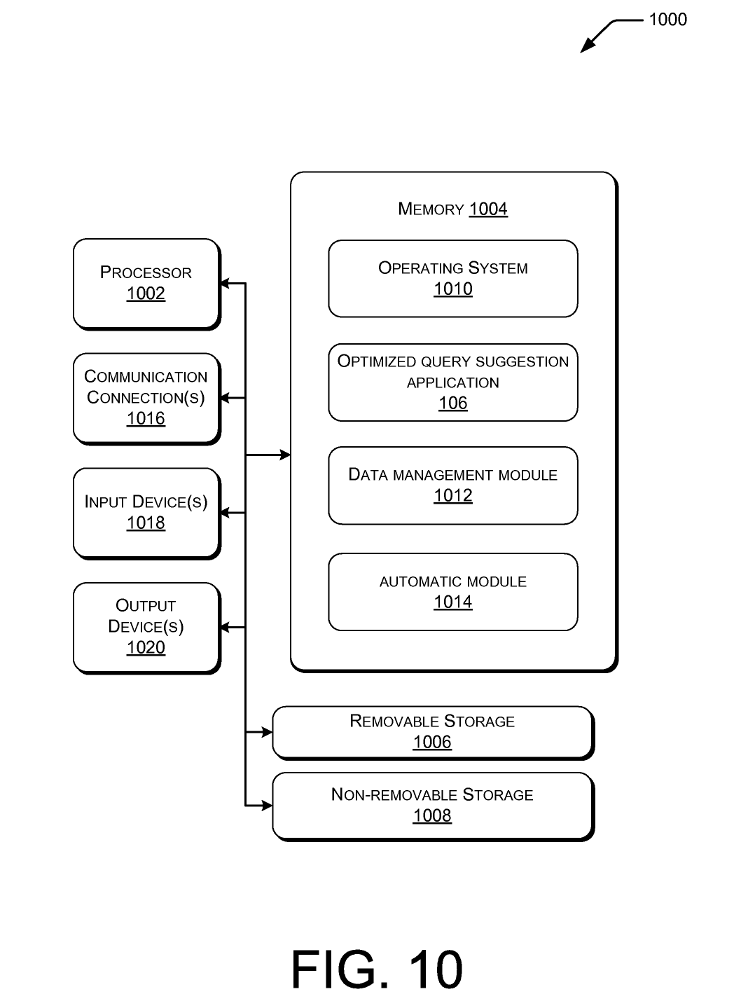

FIG. 10 is a block diagram showing an exemplary optimized query suggestion system 1000. The system 1000 may be configured as any suitable system capable of implementing optimized query suggestion application program 106. In one exemplary configuration, the system comprises at least one processor 1002 and memory 1004. The processing unit 1002 may be implemented as appropriate in hardware, software, firmware, or combinations thereof. Software or firmware implementations of the processing unit 1002 may include computer- or machine-executable instructions written in any suitable programming language to perform the various functions described.

Memory 1004 may store programs of instructions that are loadable and executable on the processor 1002, as well as data generated during the execution of these programs. Depending on the configuration and type of computing device, memory 1004 may be volatile (such as RAM) and/or non-volatile (such as ROM, flash memory, etc.). The system 1000 may also include additional removable storage 1006 and/or non-removable storage 1008 including, but not limited to, magnetic storage, optical disks, and/or tape storage. The disk drives and their associated computer-readable media may provide non-volatile storage of computer readable instructions, data structures, program modules, and other data for the communication devices.

Turning to the contents of the memory 1004 in more detail, may include an operating system 1010, one or more optimized query suggestion application program 106 for implementing all or a part of the optimized query suggestion method. For example, the system 1000 illustrates architecture of these components residing on one system or one server. Alternatively, these components may reside in multiple other locations, servers, or systems. For instance, all of the components may exist on a client side. Furthermore, two or more of the illustrated components may combine to form a single component at a single location.

In one implementation, the memory 1004 includes the optimized query suggestion application program 106, a data management module 1012, and an automatic module 1014. The data management module 1012 stores and manages storage of information, such as keywords, variety of phrases, and the like, and may communicate with one or more local and/or remote databases or services. Also, the system 1000 may include a database hosted on the processor 1002. The automatic module 1014 allows the process to operate without human intervention. For example, the automatic module 1014 may automatically cluster the query suggestions into a more structured presentation.

Computer storage media includes volatile and nonvolatile, removable and non-removable media implemented in any method or technology for storage of information such as computer readable instructions, data structures, program modules or other data. Memory 1004, removable storage 1006, and non-removable storage 1008 are all examples of computer storage media. Additional types of computer storage media that may be present include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the computing device 104.

The system 1000 may also contain communications connection(s) 1016 that allows the processor 1002 to communicate with servers, the user terminals, and/or other devices on a network. Communications connection(s) 1016 is an example of a communication media. Communication media typically embodies computer readable instructions, data structures, and program modules. By way of example, and not limitation, communication media includes wired media such as a wired network or direct-wired connection, and wireless media such as acoustic, RF, infrared and other wireless media. The term computer readable media as used herein includes both storage media and communication media.

The system 1000 may also include input device(s) 1018 such as a keyboard, mouse, pen, voice input device, touch input device, stylus, and the like, and output device(s) 1020, such as a display, monitor, speakers, printer, etc. All these devices are well known in the art and need not be discussed at length here.

The subject matter described above can be implemented in hardware, or software, or in both hardware and software. Although embodiments of click-through log mining for ads broad match have been described in language specific to structural features and/or methodological acts, it is to be understood that the subject matter defined in the appended claims is not necessarily limited to the specific features or acts described above. Rather, the specific features and acts are disclosed as exemplary forms of exemplary implementations of click-through log mining for ads broad match. For example, the methodological acts need not be performed in the order or combinations described herein, and may be performed in any combination of one or more acts.

1. A method for optimized query suggestion, implemented at least in part by a computing device, the method comprising
utilizing algorithms to identify query candidates in relationship to the submitted query;
calculating a relevance and a frequency for the query candidates in relationship to the submitted query;
generating optimized query suggestions based on a ranked score of the query candidates;
clustering the optimized query suggestions in a more structured presentation; and
describing a relationship between the optimized query suggestions and the submitted query.

2. The method of claim 1, wherein the algorithms comprise a query string and frequency algorithm, a query log session algorithm, and a search result content algorithm.

3. The method of claim 2, wherein the string and frequency algorithm comprises query candidates that are related if the query candidates include terms of the submitted query.

4. The method of claim 2, wherein the query log session algorithm comprises query candidates that are related if the query candidates appear in a substantial number of user query sessions, wherein the query sessions may be consecutive.

5. The method of claim 2, wherein the search result content algorithm comprises query candidates that are related if the query candidates have high-frequent terms or phrases of the top search results.

6. The method of claim 1, wherein calculating the relevance and the frequency comprises ranking the query candidates with a score.

7. The method of claim 1, wherein clustering the optimized query suggestions comprises organizing the optimized query suggestions in categories to improve the efficiency for a search task.

8. The method of claim 1, wherein describing the optimized query suggestions comprises at least one of a textual description or a pictorial presentation.

9. The method of claim 1, wherein the optimized query suggestion comprises a prioritized presentation in categorizing optimized query suggestions based on popular queries.

10. The method of claim 1, wherein the optimized query suggestion comprises an organized presentation in classifying optimized query suggestions by function and organizing optimized query suggestions in clusters by semantic similarity.

11. The method of claim 1, further comprising an automatic completion which comprises:
identifying prior submitted queries as the query candidates;
matching the submitted query with the prior submitted queries;
ranking the query candidates by popularity; and
offering query suggestions with refinements.

12. A computer-readable storage media comprising computer-executable instructions that, when executed, perform the method as recited in claim 1.

13. An application programming interface having computer-readable instructions that, when executed by a processor, cause the processor to perform acts comprising:
enabling entry of a submitted query;
utilizing a query string and frequency algorithm, a query log session algorithm, and a search result content algorithm to identify query candidates in relationship to a submitted query;
identifying optimized query suggestions based on a ranked score of the query candidates;
clustering the optimized query suggestions in a more structured presentation; and
providing a description of a relationship between the optimized query suggestions and the submitted query.

14. The application programming interface of claim 13, wherein the optimized query suggestion comprises a prioritized presentation in categorizing optimized query suggestions based on popular queries.

15. The application programming interface of claim 14, wherein the optimized query suggestions are categorized into a most searched displayed at a top of the search results and related searches at a bottom of the search results.

16. The application programming interface of claim 13, wherein the optimized query suggestion comprises an organized presentation in classifying optimized query suggestions by function and organizing optimized query suggestions in clusters by semantic similarity.

17. The application programming interface of claim 16, wherein the optimized query suggestions comprises classifying function of refine by and also try,
wherein refine by comprise a submitted query, a modifier, and refinements; and
wherein also try comprises related queries containing none or only part of the submitted query.

18. A computer-readable storage media comprising computer-readable instructions executed on a computing device, the computer-readable instructions comprising instructions for:
utilizing a query string and frequency algorithm, a query log session algorithm, and a search result content algorithm to identify query candidates in relationship to a submitted query;
calculating a relevance and a frequency for the query candidates, wherein the relevance and the frequency determine a ranking score of the query candidates;
clustering the optimized query suggestions based on the ranked score of the query candidates; and
describing a relationship between the optimized query suggestions and the submitted query.

19. The computer-readable storage media of claim 18, wherein clustering the optimized query suggestions comprises organizing the optimized query suggestions in categories to improve the efficiency for a search task.

20. The computer-readable storage media of claim 18, wherein describing the optimized query suggestions comprises at least one of a textual description or a pictorial presentation.
